(19) United States
(12) Patent Application Publication
(10) Pub. No.: US 2016/0353787 A1
(43) Pub. Date: Dec. 8, 2016

(54) Method of Making Smoothies and Prepackaged Frozen Smoothie Products

(71) Applicant: Brian Mitchell, Rockville, MD (US)

(72) Inventor: Brian Mitchell, Rockville, MD (US)

(21) Appl. No.: 15/088,680

(22) Filed: Apr. 1, 2016

Related U.S. Application Data
(60) Provisional application No. 62/141,832, filed on Apr. 1, 2015.

(51) Int. Cl. A23L 19/00; A23L 2/42; A23L 2/02

(52) U.S. Cl. CPC A23L 19/09; A23L 2/02; A23L 2/42; A23V 2002/00

(57) ABSTRACT

A method and apparatus for providing smoothies and in particular, green smoothies, to consumers and to retail businesses for resale without the need for a blender is disclosed. According to the method, a smoothie mixture is made according to a variety of recipes and then frozen into cubes that dimensions with surface to volume ratios that allow the cubes to be quickly reconstituted into a smoothie beverage by adding hot water and vigorously shaking the mixture. The cubes are large enough that they do not quickly thaw in the packaging and then potentially refreeze in the packaging to create a solid mass. In embodiments the cubes are divided into single serving size rigid containers wherein the consumer or reseller introduces hot water into the container.

The applicant claims the benefit of the filing date of U.S. Application No. 62/141,832 filed on Apr. 1, 2015. The present invention relates to a system, method and devices that can be used in connection with the creation of smoothies. A smoothie is a thick beverage made from blended raw fruit and or vegetables and may often contains other ingredients such as water, fragmented ice (e.g., shaved or crushed ice) protein powder, yogurt, juice and sweeteners. Smoothies are generally characterized by their use of fruit and while “green smoothies” use both fruit and vegetables in the recipe. Green smoothies are a convenient way to provide nutrition, vitamins, minerals, healthy carbohydrates and fiber that can also assist in weight loss. The American Cancer Society recommends that people eat 5-9 servings of fruits and vegetables each day to help prevent cancer and other diseases. The consumption of Green Smoothies is a quick and convenient way to follow this recommended diet, particularly with respect to vegetables and dark, leafy greens.

The fruit used in green smoothies masks the flavor of green vegetables that some may find undesirable and makes the consumption of spinach, kale, carrots, tomatoes and other vegetables more palatable. Green smoothies are also typically high in antioxidants and phytonutrients and, since Green smoothies use the whole fruit and vegetable, the mixture can be high in fiber. Much of the nutritive and disease-fighting properties of fruits and vegetable can easily go unutilized during digestion without a more thorough breakdown of the food's cell structure, in which these substances reside. Cell walls in our plant-based foods are comprised largely of cellulose, a carbohydrate that is difficult for the human body to break down, because it lacks the necessary enzymes to perform the function. The blending of fruits and vegetables together breaks down the cells of plants and improves digestibility. A blender can therefore unlock nutrients and maximize or enhance their delivery to the body.

One problem with preparing smoothies is that it is a fairly labor intensive task and requires the preparer to have a supply of a wide variety of fresh fruits and vegetables. Both fruits and vegetables have a relatively short shelf lives and maintaining an adequate supply may not be convenient. The cost and convenience of having a suitable blender for smoothies is a further consideration. Conventional low power blenders may not have high enough speed to adequately liquefy many of the ingredients and the resulting mixture may be chunky, lumpy and stringy. If a conventional consumer blender is used, the user may have to spend additional time preparing the ingredients including chopping and dicing the fruits and vegetables into small pieces.

In theory, the use of high powered blenders causes cell structure breakdown prior to consumption which translates into more energy being utilized in the forms of detoxification, disease fighting and prevention, and cell repair. A high powered blender's ability to rupture cell structure potentially yields a substantially greater increase in the percentage of phytonutrients into the bloodstream that would otherwise go unutilized. Phytonutrients, of which there are literally hundreds if not thousands found in our fruits and vegetables, reside inside the cells of their more fibrous components—skin, seeds, and pulp. The more powerful the blender, the greater its ability to aid the body in releasing properties otherwise locked inside these particular cell walls. However powerful blenders, such as those used commercially, are costly. For example, commercial grade blenders, which may have motors that exceed 2 hp or are rated between 1100-1560 watts have retail prices that typically exceed $500.00. Such products are manufactured by Viamix®, Waring®, and Blendtec®.

In addition, to the time involved in the preparation of ingredients that are used in the smoothies, there is also subsequent clean-up of the blender blades and pitcher which further contributes to additional time and inconvenience. In summary, the creation of smoothies involves significant labor and is best performed using high powered expensive equipment. All of the work, time and expense is typically expended to prepare just a few servings.

Since many smoothies includes fresh fruits and vegetables, after it is made, the beverage cannot be stored in the refrigerator for more than a few hours because the fresh ingredients will oxidize and the components tend to separate. If the beverage is made with fragmented ice, the ice will rise to the top and melt. In general, smoothies have a limited shelf life in the refrigerator. While certain health foods stores offer smoothies, in view the foregoing issues, they tend to be relatively expensive in view of the costs of the labor that is involved in preparing the beverages and the costs of the ingredients.

In some commercial settings, frozen beverages are dispensed by a dispensing apparatus having one or more large product holding containers containing a large batch, up to 10 L, of frozen beverage product that is refrigerated and, for each container, a lever or other controller can be controlled by a user to cause some of the frozen beverage product to flow out of the container and into a receptacle. These frozen beverages are not the same a fruit smoothies and the commercial devices do not include the shredder mechanisms that are required to break-up and blend the ingredients for smoothies. These devices must be frequently cleaned to prevent bacterial growth.

The operation of commercial frozen beverage systems also require the operator to first prepare a liquid mixture, once again using a blender to chop, shred, and blend the fruits and vegetables. If ice is not used in the firsts step, water would be added to the mixture to obtain a correct ratio. This liquid mixture is then poured into the product holding container that includes a dispensing apparatus. In some configurations, the container may include a freezing element for freezing up the liquid mixture around the element. Periodically an auger is activated to scrape ice formations from the freezing element. As this process continues, the liquid mixture in the product holding container becomes a frozen beverage product to be dispensed as frozen beverages. Depending on the volume of the beverage and other specifications, the conversion of the liquid mixture into the frozen beverage product may take hours.

Frozen beverage products made according to this process also have a relatively short shelf life associated to it such that, after a prescribed period of time that the product is in the container, it must be discarded and a new batch must be produced. As a result, not only are sales lost due to the freeze-down period of the product to be discarded, but there is a high percentage of waste associated with such a dispensing apparatus.

In view of the problems with providing fresh smoothies for home consumption, and the expense involved in purchasing smoothies from commercial establishments, companies have created “smoothie kits” that may be purchased for home use. However smoothie kits that are commercially available presently require the user to add the ingredients from the kit, which are often later combined with juices and then the mixture is introduced to a blender to create the beverage. For example, kits are available from Jamba Juice, Welches, Yoplait, Rader Farms, all of which typically sell the fruits, vegetable or combinations of both in single serve packages.

Others companies have sold “smoothie kits” in the form of fresh fruits and vegetables that are designed to be added to ice and also introduced to a blender for home creation and consumption. The manufacturers of such kits include Wild Oats Marketplace, DrinkGreen Smoothies of Detroit Mich. These kits have the disadvantage of a relatively short shelf life, and, while such smoothie kits have made the more accessible, they nevertheless require preparation time and the use and inconvenience of a blender to create the beverage.

Accordingly, there is a need for improved manners to provide smoothie products, and more particular, green smoothie products, to consumers for both home and commercial establishments that are both quick and easy to make.

### BRIEF SUMMARY OF EMBODIMENTS OF THE INVENTION

The present invention is therefore directed to a method and apparatus for providing smoothies and in particular, green smoothies, to consumers and to retail businesses for resale without the need for a blender. According to the method, a green smoothie mixture is made according to a variety of recipes and then frozen into cubes having specific sizes and within predetermined surface to volume ratios. The cubes have shapes and sizes that have a surface area to volume ratios that will allow the cubes to be quickly reconstituted into a smoothie beverage having an even consistency by adding hot or warm water and vigorously shaking the mixture in a single serving receptacle for a few seconds. At the same time, the cubes are large enough that they do not quickly thaw in the packaging and then potentially refreeze in the packaging to create a solid mass. The smoothie mixture is created, frozen and then the frozen cubes are divided into preselected single serving size groups and packaged. When the consumer is ready to drink the beverage, hot water is added and the mixture is reconstituted into a smoothie mixture.

### BRIEF DESCRIPTION OF THE DRAWINGS

FIG. 1 depicts an ice tray that will make smoothie cubes in the shape of a right cylinder that can be used according to embodiments of the invention.

FIG. 2 depicts an ice tray that will make a smoothie cubes having bullet shape with spherical ends according to embodiments the invention.

FIG. 3 depicts an ice tray that will make a square smoothie cubes according to the invention.

FIG. 4 depicts an ice tray that will make a square pyramid shaped cubes according to the invention.

FIG. 5 depicts a rigid wide mouth container in perspective according an embodiment of the invention.

FIG. 6 depicts a coated fiberboard container in perspective according to a further embodiment of the invention.

FIG. 7 is a flow chart describing the method of the invention.

### DETAILED DESCRIPTION OF EMBODIMENTS OF THE INVENTION

Examples of ice trays that may be used in accordance with the teaching of the invention are illustrated in FIGS. 1-4 and include trays with square shaped voids, cylinder shaped voids, and pyramid shaped voids and voids with semi-spherical profiles. While the applicant describes the frozen pieces that are formed in the voids as “cubes,” or ice cubes the term is used herein describe any shaped frozen piece that is formed into a predefined shapes and my include cylinders, three dimensional solids defined by walls of various polygonal shapes, disks, spheres, cones, pyramids, triangular prisms, rectangular prism, other prisms and fractional sections thereof as well as combinations of the foregoing three dimensional geometric shapes. The size of the cube is selected to allow the rapid reconstitution using hot water and nevertheless are large enough that the cubes to be frozen without excessive binding together into a single mass. The size of the cubes that are particularly useful is an important feature of the invention. In this regard, in an embodiments, it is also important to be able to separate the cubes from packaging and introduce them individually into the opening of shaker jar. If the cubes are too small they will tend to bind together into a single mass when frozen. If they are too large, they will not quickly reconstitute into a smooth and consistent beverage.

Referring to FIG. 1, a first ice cube tray 101 in which frozen smoothie pieces may be made has a length 1040 of 24 cm and a width of approximately 13 cm. A series of voids such as void 109 are provided each of which has the shape of a right cylinder are provide that each of a radius is 1.125 and a height of 2.25 cm. In this embodiment the surface area is 23.86 and the volume is 8.95 cc. and the surface to volume ratio is 2.66.

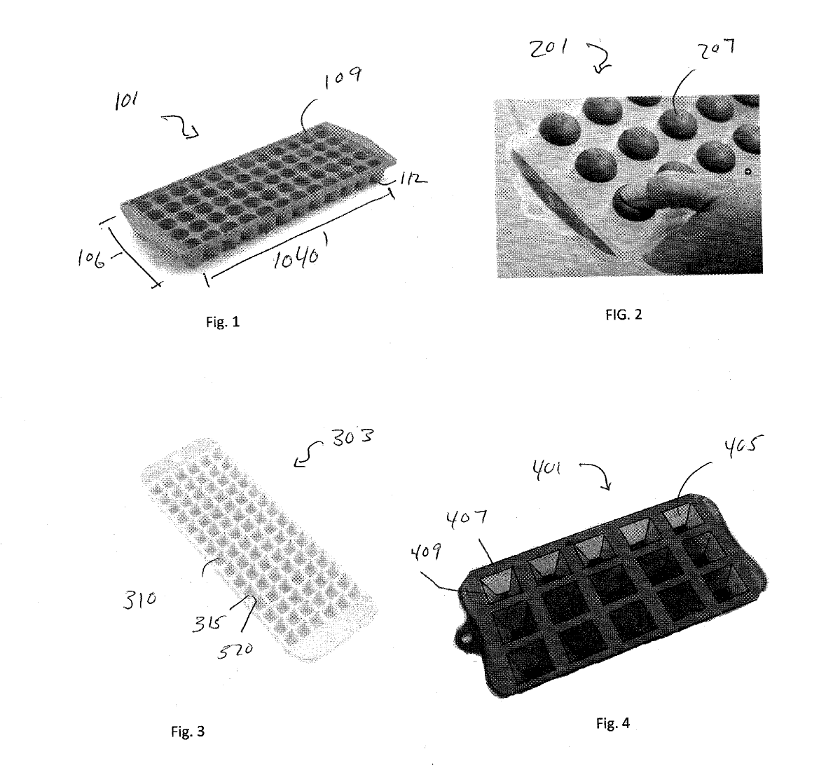

FIG. 2 depicts an ice tray 201 that can create frozen pieces that have semi-spherical profile. The frozen pieces can be displaced by manipulation of the flexible end wall 207.

Now referring to FIG. 3, an ice tray 303 is depicted that has openings that are approximately 2.0 cm by 2.0 cm and are 2.0 cm deep. The cubes made by this embodiment therefor have a volume of 8.0 ccm and a surface area of 24.0 ccm. This embodiment has a surface to volume ratio of 3.5.

FIG. 4 depicts an ice tray 401 that can create frozen pieces in the shape of a square pyramid. In a further embodiment the frozen unit is formed in the shape of a pyramid having a square base and the base length is 2 cm. the base width is 2 cm and the height is 2 cm. In this this embodiment the surface area 12.94 cm and the volume is about 2.67 cm. and the surface to volume ratio is 4.84.

FIGS. 1-4 depict alternative and shaped voids for ice cubes. The width of each of the trays depicted in FIGS. 1-4 are approximately 11 cm wide and they have a length of approximately 24 cm. Many ice tray that can be advantageously used are commercially available and some are referred to as mini-cube trays.

In a further example, not shown, an ice tray used in accordance with an embodiment of the invention has square shaped voids having dimension of 1.25 cm×1.25 cm by 1.25 cm and has a volume of 1.42 cc and a surface area of 7.59.

In another embodiment the “cube” is in the shape of a right cylinder that has a diameter 2.0 cm and a height of 2.0 cm. In this embodiment surface area is approximately 18.85 cm and the volume is 6.28 cc. and the surface to volume ratio is 3.00.

In yet a further embodiment the “cube” is a right cylinder and the radius is 0.5 cm and a height of 1 cm. In this embodiment the surface area is 4.71 and the volume is 0.79 cc. and the surface to volume ratio is 5.96.

In a further embodiment the “cube” is in the shape of a pyramid and the base length is 2.25 cm the base width is 2.25 cm and the height is 2.25 cm In this this embodiment the surface area is 16.38 cm and the volume is about 3.0 cm and the surface to volume ratio is 5.46. In yet a further embodiment the “cube” is in the shape of a pyramid and the base length is 1 cm, a base width of 1 cm and the height is 1 cm. In this this embodiment the surface area 12.94 cm and the volume is about 0.33 cm.

It is not recommended to have a surface to volume ratio that exceeds 10.0 and the preferred that the area to volume ration is not less than 2.5 or more than 8. Optimal surface to volume ratio for the frozen units are between 2 and 8.

As discussed above, the size and surface area of the cubes is are important so that, when mixed with hot water, the mixture will quickly melt and create a beverage with a smooth and even consistency. The cubes should be large enough so that they can be easily separated when in a bag to enable the user to introduce the cubes individually into the opening of shaker jar. If the cubes are too small they will tend to bind together. At a minimum the cubes should have at least two of the height, length or width dimension of 1 cm and does not exceed 2.5 cm. Larger cubes will not rapidly break up and therefore will not be properly reconstituted into a mixture with an even consistency for consumption. The size of the cubes should not exceed 2.25 cm by 2.25 by 2.25 cm.

In an embodiment wherein there is a cube having a 2.25 cm×2.25cm×2.25 cm the surface area is 30.38 and the volume is 11.39 and the surface areas to volume ration is 2.66.

In another embodiment the “cube” is in the shape of a right cylinder that has a diameter of 2.0 cm and a height of 2.0 cm. In this embodiment surface area is approximately 18.85 cm and the Volume is 6.28 cc. and the surface to volume ratio is 3.00.

In a further embodiment the “cube” is a right cylinder and the radius is 1.125 and a height of 2.25 cm. In this embodiment the area is 23.86 and the volume is 8.95 cc. and the surface to volume ratio is 2.66.

In a further embodiment the “cube” is a right cylinder and the radius is 0.5 cm and a height of 1 cm. In this embodiment the surface area is 4.71 and the volume is 0.79 cc. and the surface to volume ratio is 5.96. In a further embodiment the “cube” is in the shape of a pyramid and the base length is 2 cm. the base width is 2 cm and the height is 2 cm. In this this embodiment the surface area 12.94 cm and the volume is about 2.67 cm. and the surface to volume ratio is 4.84.

In a further embodiment the “cube” is in the shape of a pyramid and the base length is 2.25 cm. the base width is 2.25 cm and the height is 2.25 cm. In this this embodiment the surface area is 16.38 cm and the volume is about 3.0 cm and the surface to volume ratio is 5.46.

Exemplary embodiments of the smoothie concentrate are as follows: Example 1. A smoothie premix is made according to the following recipe, blueberry 35%, lemon juice 5%, date 10%, kale 10%, spinach 2% and water 15% by weight. The ingredients are then put into a blender until all of the materials are completely blended into a liquid slurry. Next the slurry is introduced to the ice trays are described herein and frozen.

In embodiments, the smoothie concentrate is frozen using a flash freeze process. Flash freezing refers to the process whereby objects are quickly frozen by subjecting them to cryogenic temperatures, or in direct contact with liquid nitrogen at −196° C. Flash freezing is presently used in the food industry to quickly freeze perishable food items. Food items are subjected to temperatures well below water's melting/freezing point. The freezing process results in ice crystals formed from intra- and extracellular water, and subsequent crystal growth. The freezing speed directly influences the nucleation process and ice crystal size. Consequently, decreased growth of the initially formed ice crystals is a result of a high heat removal rate and causes an increased rate of nucleation. Smaller, more ubiquitous ice crystals that are formed in the flash freezing process cause less damage to cell membranes and other cell structures. It is reported that that this freezing technique quickly further reduces damage to live enzymes, cell walls and plant nutrients. In embodiments the flash freezing uses a blast freezer which is a freezer which is extremely cold. Such freezers preserve food at very low temperatures, freezing it extremely quickly. A blast freezer can reduce temperature of a food from +70 degrees C. to −18 degrees C. in less than 4 hours. In addition to reduced damage to cell structures, bacteria cannot thrive in the extremely cold environment of blast freezers. Freezing in either a blast freezer or a normal freezer is preferred over heat pasteurization and high pressure processing (HPP) techniques that are commonly used at preserving nutrients and enzymes.

In further embodiments, the smoothie premix is first subjected to blast chilling, a method of cooling food quickly to a low temperature that is relatively safe from bacterial growth. In this regard, bacteria multiply fastest between +8° C. (46° F.) and +68° C. (154° F.), by reducing the temperature of cooked food from +70° C. (158° F.) to +3° C. (37° F.) or below within 90 minutes, the food is rendered safe for storage and later consumption. This method of preserving food is commonly used in food catering and, recently, in the preparation of ‘instant’ foods, as it is considered to improve food safety and preservers the quality of the food product.

According to a method of the invention, frozen smoothie material is made, such as using one of exemplary recipes provide here and then introduced to ice trays as described above and then frozen according to a method described above. The frozen cubes can then be packaged into single serving increments in bags or other receptacles. In a preferred embodiment the single serving size is seven ounces by weight. When a user is ready to consume a smoothie, the frozen cubes are reconstituted using boiling water. In this embodiment using the forgoing recipe and frozen cubes, 7 ounces of smoothie cubes (by weight) are combined with approximately ¾ cup or 6 fluid ounces of hot water. The water should be at or very close to boiling (212 Fahrenheit) and then combined in a jar or suitable shaker having a volume of about 16 oz. Next the receptacle is shaken for five to fifteen seconds. The hot water will thaw the cubes in less than 4 minutes. After the water and cubes are combined it will thaw in about 2.5 minutes after 2 shakes. In summary, the cubes are combined with the hot water, the mixture is shaken in a jar or rigid package, it is allowed to sit for a minute or two, the mixture is shaken again and the is then ready for consumption.

In an alternative embodiment, the cubes of concentrated smoothie are introduced into a shaker receptacle with hot water, delivered from an ordinary faucet. Water from faucets is typically delivered at temperatures that do not exceed 125° F. (51.66° C.).

In yet a further embodiment the frozen cubes are introduced to a single serving container having relatively rigid sidewalls. Referring now to FIG. 5 smoothie cubes 512 are sold in a reusable cup 501 made from thermoplastic having a wide-mouth top opening for filling the container. A lid 507 is provided to seal the container using conventional sealing techniques. Polyethylene containers are preferred because they can withstand both freezing temperatures required for storage of the product and very hot temperatures, which the container is subjected to in the preparation steps. The cubes are filled about three quarters of the container and a space 509 is provided to facilitate the shaking of the container after the water is added. A fill line 515 is provided so the prepared is not required to premeasure the hot water. the

[symbol]

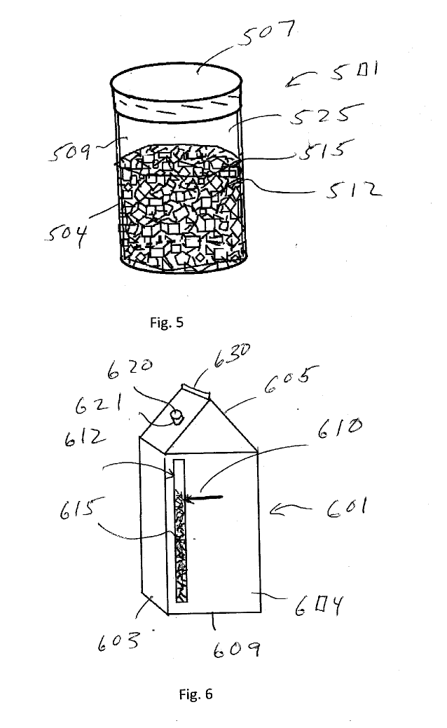

FIG. 6 depicts a further embodiment of the invention wherein the frozen smoothie units described above are provided in single-serving cardboard milk cartons type containers. The carton 601 depicted in FIG. 6, referred to as gable top carton, and has a flat side wall or surfaces 604 and a top portion including inclined walls or surfaces 605 and 606 which are joined at the top portions thereof to form a flange or lip 630. This container is sealed in the manufacturer's plant and the seal must be opened in order to gain access to the contents of the carton. The frozen smoothie cubes or units are introduce to the container before sealing. The cardboard cartons can be the usual wax coated or plastic coated cartons, normally coated with polyethylene material.

The carton includes a spout 621 can be made of any suitable material, preferably molded from a suitable plastic material, and it has been found desirable to injection mold the spout 621 from such as polystyrene polyepoxies, vinyl plastics, polyethylene, polypropylene, etc. The spout 621 includes a removable screw cap 620. An elongated transparent window section 612 is provide on a sidewall 604 of the container to allow the users to inspect the contents but more importantly to monitor the preferred fill line 610. It is preferred to leave space at the top of the container to facilitate shaking of the contents. When the product is ready for consumption, liquid is introduced to the container and the mixture is shaken. In a further embodiment, the contained has a top opening in the form of a spout, neck or passage designed for drinking. In a further embodiment the top opening is re-sealable. In a further embodiment the cubes are packaged in a disposable container such as a bag having flexible side walls and the end user introduces the cubes into a reusable receptacle for shaking the mixture.

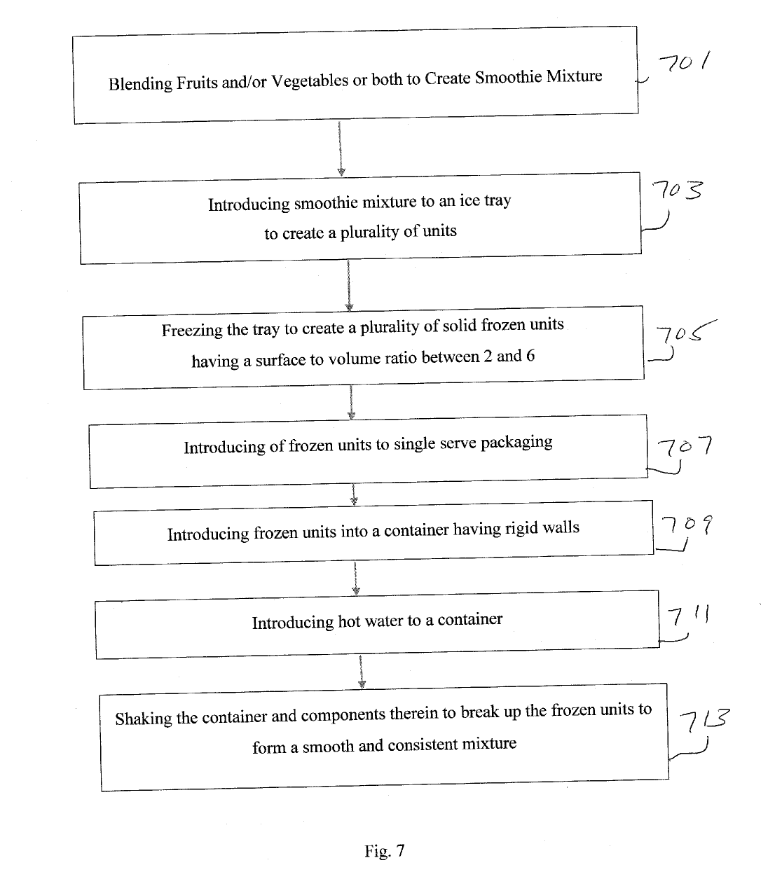

In a further an embodiment the cubes are introduced to the fill end of a single serve disposable container such as a conventional cardboard milk carton, or juice box container or tetra-pack style container. When the product is ready for use, hot or warm water is introduced to the container. FIG. 7 describes a method of the invention including the steps of blending fruits and/or vegetables or both to create a smoothie mixture in step 701, introducing smoothie mixture to an ice tray to create a plurality of units in step 703, freezing the tray to create a plurality of solid frozen units having a surface to volume ratio between 2 and 6 in step 705, Introducing frozen units to single serve packaging in step 707, Introducing frozen units into a container having rigid walls in step 709, Introducing hot water to a container in step 711 and Shaking the container and components therein to break up the frozen units to form a smooth and consistent mixture in step 713.

The packaged servings can be stored in conventional home freezers or are delivered to commercial establishments where they remain frozen until ready for use. In embodiments the product is provided to the purchaser in insulated freezer bags which can be then added to the consumer's shaker container.

The present invention has been illustrated and described with respect to specific embodiments thereof, which embodiments are merely illustrative of the principles of the invention and are not intended to be exclusive or otherwise limiting embodiments. Accordingly, although the above description of illustrative embodiments of the present invention, as well as various illustrative modifications and features thereof, provides many specificities, these enabling details should not be construed as limiting the scope of the invention, and it will be readily understood by those persons skilled in the art that the present invention is susceptible to many modifications, adaptations, variations, omissions, additions, and equivalent implementations without departing from this scope and without diminishing its attendant advantages. It is further noted that the terms and expressions have been used as terms of description and not terms of limitation. There is no intention to use the terms or expressions to exclude any equivalents of features shown and described or portions thereof. Additionally, the present invention may be practiced without necessarily providing one or more of the advantages described herein or otherwise understood in view of the disclosure and/or that may be realized in some embodiments thereof. It is therefore intended that the present invention is not limited to the disclosed embodiments but should be defined in accordance with the claims that follow.

We claim:

1. A method of making a smoothie comprising the steps of (1) preparing a smoothie mixture comprising fruit, (2) introducing the smoothie mixture to an tray having a plurality of voids to create a plurality of units, (3) freezing said tray to create frozen units, said units having a surface to volume ratio between 2 and 40 (4) introducing said frozen units into a container having ridged walls, (5) introducing hot water into said container, (6) shaking said container to break up said frozen units to form a smooth and consistent mixture.

2. The method of claim 1 further comprising introducing said frozen units into single serve packaging.

3. The method of claim 1 wherein said frozen units further comprise blended vegetables.

4. The method of claim 1 wherein said single serve container further comprises a fiberboard container.

5. The method of claim 4 wherein said container further comprises a pour spouts.

6. The method of claim 5 wherein said pour spot may be sealed, opened and resealed.

7. The method of claim 6 wherein said spout further comprises a screw cap.

8. A smoothie mixture kit comprising a sealed container holding a plurality of frozen units comprised of blended fruit, said units having a surface to volume ration of between 2 and 10, and said container further comprising a single serving size.

9. The smoothie mixture kit of claim 8 wherein said container further comprises a coated fiberboard box.

10. The smoothie mixture kit of claim 8 wherein said container further comprises a transparent region that is oriented on the sidewall of said container that permits inspection of the fluid level within said container.

11. The smoothie mixture kit of claim 8 wherein said container further comprising a rigid wide mouth reusable container.

12. The smoothie mixture kit of claim 11 wherein said container comprises polypropylene.

13. A method of making a smoothie using the kit recited in claim 6 comprising the steps of adding hot water to said container, and then shaking said container to break-up said frozen units.

14. The smoothie kit as recited in claim 8 wherein said frozen units are generally cubed shaped and each face has dimensions of between 1.5 cm and 3.0 cm.

15. The smoothie kit as recited in claim 8 wherein said cubes are generally in the shape of a right cylinder and have a dimensions of a based diameter of 1.5 to 2.5 cm and a height between 1.5 and 2.5 cm.

16. The smoothie kit as recited in claim 8 wherein said cubes are generally in the shape of a square pyramid and have a base with a dimensions of between 1.5 and a height between 1.5 and 2.5 cm.
